(19) United States
(12) Patent Application Publication
(10) Pub. No.: US 2008/0285401 A1
(43) Pub. Date: Nov. 20, 2008

(54) OPTICAL DISC APPARATUS AND OPTICAL DISC RECORDING AND REPRODUCING METHOD

(75) Inventors: Yuichi Ito, Tokyo (JP); Tatsuji Ashitani, Tokyo (JP); Takahiro Mihara, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/106,030

(22) Filed: Apr. 18, 2008

(30) Foreign Application Priority Data
May 16, 2007 (JP) 2007-130843

(51) Int. Cl. G11B 20/10

(52) U.S. Cl. 369/47.5

(57) ABSTRACT

According to one embodiment, there is provided an optical disc apparatus including: a recording unit forming a mark and a space having a predetermined code length by using a laser beam and, thus, recording data on an optical disc; a crest value acquiring unit acquiring a crest value of the mark and the space for each code length from a readout signal of the optical disc; an asymmetry calculation unit calculating asymmetry value for each code length from the crest value; and a recoding parameter determining unit determining, based on a linear characteristic between the asymmetry value for each code length and the recording power level, an optimal recording parameter including an optimal recording power level of the laser beam, the recoding parameter determining unit determining the optimal recording power level to set the asymmetry value for each code length within a predetermined range.

### CROSS-REFERENCE TO RELATED APPLICATIONS

This application is based upon and claims the benefit of priority from Japanese Patent Application No. 2007-130843, filed on May 16, 2007, the entire contents of which are incorporated herein by reference.

### BACKGROUND

1. Field

One embodiment of the invention relates to an optical disc apparatus and an optical disc recording and reproducing method, and more particularly, to an optical disc apparatus and an optical disc recording and reproducing method which record/reproduce data on rewritable optical discs.

2. Description of the Related Art

As rewritable optical discs, there are DVD-RWs, DVD-RAMs, HD DVD-RWs, and HD DVD-RAMs, as examples. It is known that the quality of recording signals recorded on these rewritable optical discs depends on recording parameters such as a laser power level for recording and a waveform of a recording signal. Accordingly, a general process in which a test period is provided at a time after insertion of an optical disc into an optical disc apparatus or the like and optimal recording parameters are acquired during the test period is performed.

In selecting evaluation indexes for acquiring the optimal recording parameters, it is disclosed by, for example JP-A-2001-126254, that vertical symmetry of a readout signal, that is, a so-called asymmetry value β is used as the evaluation index and a pulse width of a recording pulse is adjusted so as to make the asymmetry value β to be in an appropriate range.

The asymmetry value β that is generally used is an index indicating symmetry of average DC level of the whole code lengths (code length of 3T to 11T for CDs or general-type DVDs). Hereinafter, the code lengths mean lengths of mark/space. Accordingly, it cannot be determined that asymmetry values for each code length become zero. For example, there may be a case where the average asymmetry value β is zero even when asymmetry of the code length of 3T is deviated toward a positive side and asymmetry of the code length of 4T is deviated toward a negative side.

When high-density recording-type optical discs such as HD DVDs are used, the effect of asymmetry (dissymmetry) on the quality of readout signals increases, compared to a case where general CDs or DVDs are used. Accordingly, it is required to control the asymmetry more delicately. In other words, there is required control technique by which individual asymmetry values of each code length is made to be close to zero along with making the average asymmetry value of the whole code lengths zero as in the general technology.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing a structure of an optical disc apparatus according to an embodiment of the present invention.

FIGS. 2(a), 2(b) are exemplary diagrams showing a relationship between recording power levels and a mark and a space of an optical disc.

FIG. 3 is an exemplary schematic diagram showing a relationship between the mark and space formed on the optical disc and readout signals of the space and the mark.

FIG. 4 is an exemplary diagram for describing an equation for calculating asymmetry values.

FIG. 5 is an exemplary schematic diagram showing control of a recording power level and changes of crest values.

FIG. 6 is an exemplary diagram showing a measured relationship between a code length and an asymmetry value with a recording power level set as a parameter, as an example.

FIG. 7 is an exemplary diagram showing a measured relationship between a recording power level and an asymmetry value with a code length set as a parameter.

FIG. 8 is an exemplary flowchart showing a process of an asymmetry control method according to a first embodiment of the invention.

FIG. 9 is an exemplary additional diagram showing an asymmetry control method according to the first embodiment.

FIG. 10 is an exemplary diagram showing an example of asymmetry values for each code length before and after an asymmetry control method according to the first embodiment.

FIG. 11 is an exemplary diagram showing a linear approximation process used in an asymmetry control method according to a second embodiment of the invention.

FIG. 12 is an exemplary diagram of a characteristic of a slope θ in a linear approximation equation with respect to a recording power level.

FIG. 13 is an exemplary flowchart showing a process of an asymmetry control method according to the second embodiment.

FIG. 14 is an exemplary diagram showing an example of asymmetry values for each code length before and after an asymmetry control method according to the second embodiment.

FIG. 15 is an exemplary diagram showing a process of an asymmetry control method for each code length by adjusting a pulse width.

FIG. 16 is an exemplary diagram showing a limitation of the asymmetry control method on the basis of pulse width adjustment.

FIGS. 17(a), 17(b) are exemplary diagrams showing an asymmetry control method according to a third embodiment of the invention.

FIG. 18 is an exemplary flowchart showing a process of an asymmetry control method according to the third embodiment.

FIGS. 19(a), 19(b) are exemplary diagrams showing an asymmetry control method according to a fourth embodiment of the invention.

FIG. 20 is an exemplary flowchart showing a process of an asymmetry control method according to the fourth embodiment.

FIG. 21 is an exemplary flowchart showing a process of an asymmetry control method according to the fourth embodiment.

### DETAILED DESCRIPTION

Various embodiments according to the invention will be described hereinafter with reference to the accompanying drawings. In general, according to one embodiment of the invention, there is provided an optical disc apparatus including: a recording unit forming a mark and a space having a predetermined code length by using a laser beam and, thus, recording data on an optical disc; a crest value acquiring unit acquiring a crest value of the mark and the space for each code length from a readout signal of the optical disc; an asymmetry calculation unit calculating asymmetry value for each code length from the crest value; and a recoding parameter determining unit determining, based on a linear characteristic between the asymmetry value for each code length and the recording power level, an optimal recording parameter including an optimal recording power level of the laser beam, the recoding parameter determining unit determining the optimal recording power level to set the asymmetry value for each code length within a predetermined range.

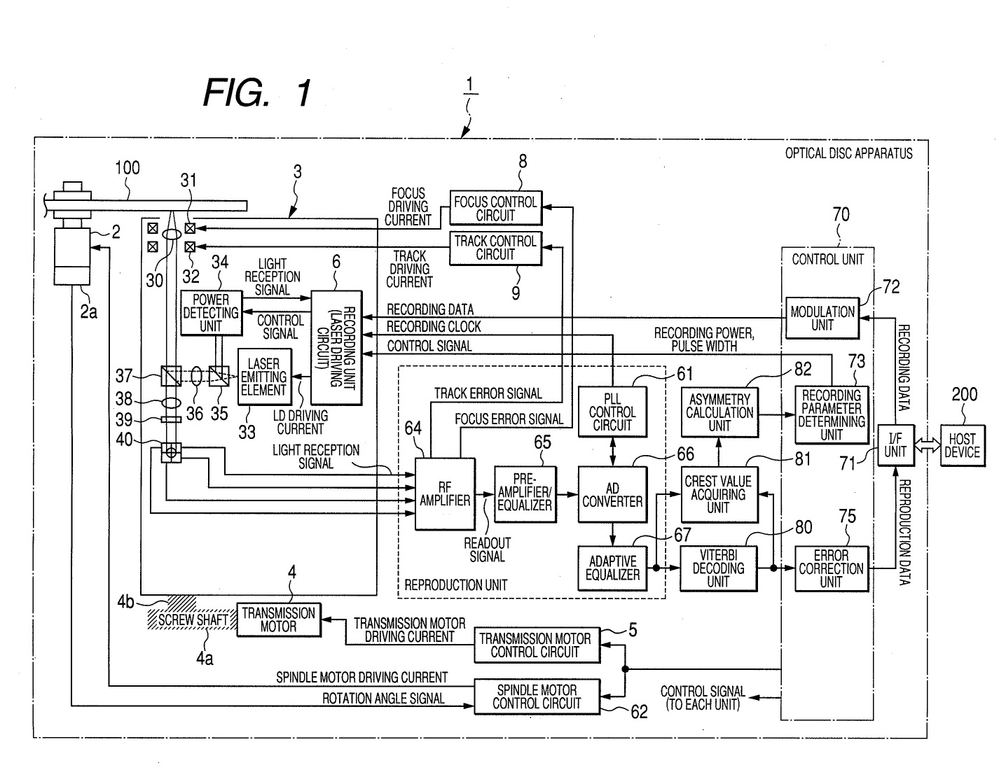

Hereinafter, a structure and overall operation of optical disc apparatus are described. FIG. 1 is a diagram showing a structure of an optical disc apparatus 1 according to an embodiment of the invention.

The optical disc apparatus 1 records and reproduces information on a rewritable optical disc 100 such as a DVD-RW, a DVD-RAM, an HD DVD-RW, or an HD DVD-RAM. On the optical disc 100, there is a spiral guide way. Concave portions of the guide way are called grooves and convex portions of the guide way are called lands, and one circle of each one of the grooves or the lands is called a track. User's data is recorded on the optical disc by an irradiating intensity-modulated laser beam along the track (the groove only or both the groove and the land) so as to form marks and spaces corresponding to the code length of the data.

The data is reproduced by irradiating a laser beam having a power level (read power level) for reading, which is lower than that for recording, along the track and detecting changes in the intensity of light reflected from the marks and the spaces on the track. The recorded data is erased by irradiating a laser beam having a power level (erase power level) for erasing, which is higher than that for reading, along the track and performing a crystallization process for a recording layer.

The optical disc 100 is driven for rotation by a spindle motor 2. A rotation angle signal is supplied from a rotary encoder 2a that is provided in the spindle motor 2. As the rotation angle signal, for example, five pluses are generated for each rotation of the spindle motor 2. The rotation angle and number of rotations of the spindle motor 2 can be determined from the rotation angle signal, and thus a spindle motor control circuit 62 controls the rotation of the spindle motor 2 on the basis of the information on the rotation angle and number of rotations of the spindle motor 2.

The recording and readout of the optical disc 100 is performed by an optical pickup 3. The optical pickup 3 is connected to a transmission motor 4 through a gear 4b and a screw shaft 4a, and the transmission motor 4 is controlled by a transmission motor control circuit 5. The transmission motor 4 is rotated by a transmission motor driving current sent from the transmission motor control circuit 5, and thereby the optical pickup 3 moves in a radial direction of the optical disc 100.

An objective lens 30 that is supported by a wire or a plate spring (not shown) is provided in the optical pickup 3. The objective lens 30 can be moved in a focusing direction (optical axial direction of the objective lens 30) by driving a driving coil 31. In addition, the objective lens 30 can be moved in a tracking direction (a direction perpendicular to the optical axis of the objective lens 30) by driving a driving coil 32.

A laser driving circuit (recording unit) 6, supplies a driving current for writing to a laser diode (laser emitting element) 33 on the basis of recording data modulated by a modulation unit 72 using an ETM (Eight to Twelve Modulation) method or the like. To the modulation unit 72, the recording data is supplied from a host device 200 such as a personal computer through an I/F unit 71.

The laser driving circuit 6 supplies a driving current for reading, which is smaller than the current for writing, to the laser diode 33 when the information is to be read.

A power detecting unit 34 (referred to as a front monitor (FM) in some cases) that is constituted by a photo diode and the like divides a predetermined ratio of the laser beam generated by the laser emitting element 33 by using a half mirror 35 and detects a signal in proportion to a light intensity, that is, a power level of light emission as a light reception signal. The detected light reception signal is supplied to the laser driving circuit 6. The laser driving circuit 6 controls the laser emitting element 33 on the basis of the light reception signal sent from the power detecting unit 34 so as to emit light at a recording power level, a recording pulse width, a power level for reproduction, and a power level for erasing that are determined to be set by a recording parameter determining unit 73 of the control unit 70 or the like.

The laser emitting element 33 generates a laser beam on the basis of the driving current supplied from the laser driving circuit 6. The laser beam generated from the laser emitting element 33 is irradiated on the optical disc 100 through a collimator lens 36, a half prism 37, and the objective lens 30.

On the other hand, light reflected from the optical disc 100 is guided to a light detector 40 through the objective lens 30, the half prism 37, a condensing lens 38, and a cylindrical lens 39.

The light detector 40, for example, has a four-divided light detecting cell, and detection signals from the light detecting cell is output to an RF amplifier 64 of a reproduction unit 60. The RF amplifier 64 processes the signals from the light detecting cell and generates a focus error signal FE indicating an error deviated from a just focus position, a tracking error signal TE indicating en error between the center of a beam spot of the laser beam and the center of a track, and a readout signal that is a signal generated by the sum of the signals from the light detecting cell.

The focus error signal FE is supplied to a focus control circuit 8. The focus control circuit 8 generates a focus driving signal in accordance with the focus error signal FE. The focus driving signal is supplied to the driving coil 31 for the movement in the focusing direction. Thereby, a focus servo control operation by which the laser beam is continuously located in just focus positions on a recording film of the optical disc 100 is performed.

The tracking error signal TE is supplied to a track control circuit 9. The track control circuit 9 generates a track driving signal in accordance with the tracking error signal TE. The driving signal output from the track control circuit 9 is supplied to the driving coil 32 for the movement in the tracking direction. Thereby, a tracking servo control operation by which the laser beam continues to trace a track formed on the optical disc 100 is performed.

By the above-described servo control and tracking servo operations, the focus of the laser beam can trace the tracks on a recording surface of the optical disc with a high precision. As a result, changes in a beam reflected from the marks or the spaces which are formed on the tracks of the optical disc 100 in accordance with recording information are correctly reflected to the sum signal RF of the output signals of light detecting cells of the light detector 40, whereby it is possible to acquire readout signals having excellent quality.

This production signal (the sum signal RF) is input to a pre-amplifier/equalizer 65. The production signal is amplified to have an appropriate amplitude by the pre-amplifier/equalizer 65, and then an operation for shaping the waveform thereof is performed. The output of the pre-amplifier/equalizer 65 is sampled by an AD converter 66 in accordance with reproduction clock signals sent from a PLL control circuit 61 and is converted into multi-valued digital data.

The digital readout signal is input to an adaptive equalizer 67, and a waveform equalization process in accordance with a predetermined partial response type (class) is performed for the input signal. The adaptive equalizer 67, for example, has an adaptive transversal filter. The waveform equalization process is performed by adapting a weighting factor such that an error between reference data that is generated so as to have an ideal partial response for decoding data decoded by a Viterbi decoding unit 80 in the latter stage and input data becomes zero.

An equalized readout signal that is an output of the adaptive equalizer 67 is input to the Viterbi decoding unit 80. The Viterbi decoding unit 80 decodes the input equalized readout signal series into the recording data by a Viterbi decoding process using a maximum likelihood estimation method for acquiring decoding data.

The decoding data is input to an error correction unit 75. An error correction process is performed for the decoding data by the error correction unit 75, and the corrected decoding data is output to the host device 200 through an I/F unit 71.

To a crest value acquiring unit 81, the equalized readout signal that is an output of the adaptive equalizer 67 and the decoding data that is an output of the Viterbi decoding unit 80 are input. The crest value acquiring unit 81 extracts crest values (peak values and bottom values) of each code length from the equalized readout signal.

The crest values extracted by the crest value acquiring unit 81 are input to an asymmetry calculation unit 82. Asymmetry values are calculated by the asymmetry calculation unit 82 as evaluation values for determining optimal recording parameters such as a recording power level or an optimal recording pulse width.

The optimal recording parameters such as the optimal recording power or the optimal recording pulse width are determined by the recording parameter determining unit 73 on the basis of the asymmetry values calculated by the asymmetry calculating unit 82, and the determined optimal recording parameters are set in the recording unit (laser driving circuit) 6.

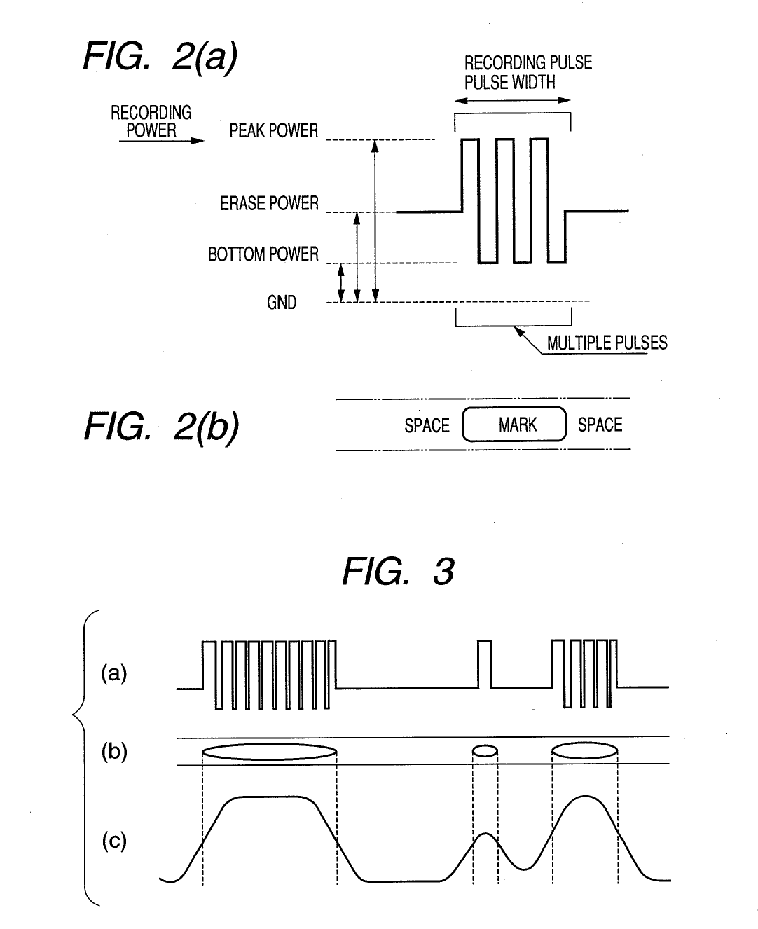

FIGS. 2(a), 2(b) are schematic diagrams showing a recording waveform generated on the basis of the recording parameters set in the recording unit 6 and the marks and spaces formed in accordance with the recording waveform on the tracks of the optical disc 100. Generally, as shown in FIG. 2(a), multiple pulses are used for forming the mark. The multiple pulses are constituted by a plurality of pulse trains in which a recording power level (peak power level) and a bottom power level are repeated. Here, the whole width of the multiple pulses is referred to as a pulse width of a recording pulse or is abbreviated as a pulse width. The erase power level that is in the middle between the recording power level and the bottom power level is used for forming the space on the tracks.

The number of pulse trains or width of each pulse train constituting the multiple pulses is predetermined on the basis of a code length (the length of the mark or space; mostly 3T to 11T for general DVDs and mostly 2T to 11T for HD DVDs) of data to be recorded.

FIG. 3 shows schematic diagrams of recording waveforms for different code lengths (FIG. 3(a)), the marks and spaces formed on the tracks (FIG. 3(b)) and the readout signals thereof (FIG. 3(c)). As shown in FIG. 3(c), the crest value (the peak value or bottom value) of a readout signal having a short code length is small and increases as the length of the code length of the readout signal increases. When the code length of the readout signal becomes larger than a specific value, the crest value of the readout signal is saturated, and accordingly, an upper portion of the waveform of the readout signal becomes flat.

Hereinafter, several asymmetry control methods according to embodiments of the invention, which are performed in the optical disc apparatus 1, will be described. The asymmetry control method is mainly performed by the asymmetry calculating unit 82 and the recording parameter determining unit 73.

Hereinafter, an asymmetry control method according to a first embodiment is described. Before describing the asymmetry control method according to a first embodiment of the invention, a general asymmetry control method will be described briefly.

There has been performed a typical asymmetry control method in which an evaluation index referred to as a so-called asymmetry value □ is acquired and a recording power level is controlled (including an equivalent control operation of the recording power level by controlling the pulse width) so as to approach the asymmetry value β to zero. This recording power control method is called OPC (Optimum Power Control), and hereinafter the OPC using the asymmetry value β will be referred to as a general-type OPC for differentiation between the OPC and a recording power control method according to an embodiment of the invention. There are the following general types of OPCs.

At first, a peak detecting operation and a bottom detecting operation are performed with reference to a DC level of a readout waveform, whereby a peak value VH and a bottom value VL of the readout waveform are acquired. Next, an asymmetry value β that indicates symmetry of the readout waveform is acquired from the peak value VH and the bottom value VL by using the following equation.

β=(VH+VL)/(VH−VL) (Equation 1)

The recording power that allows the asymmetry value □ to be zero is acquired.

However, since the asymmetry value β, which is used in the general-type OPC, is an index indicating asymmetry of an average DC level of whole code lengths (for a CD or a general-type DVD, a code length of 3T to 11T, wherein T is a unit length of a code length), it cannot be determined that the asymmetry values for each code length become zero. For example, there is a case where the average asymmetry value β is zero although an asymmetry value for the code length of 3T is deviated toward a positive side and an asymmetry value for the code length of 4T is deviated toward a negative side.

Furthermore, an effect of the asymmetry (dissymmetry) on the quality of readout signals for high-definition recording-type optical discs such as HD DVDs is larger than that for CDs or general DVDs. Accordingly, there is need for controlling the asymmetry more delicately. In other words, a control technique for approaching asymmetries for each code, along with asymmetry for the whole code length, to zero is used.

Accordingly, the asymmetry values for each code length are calculated as below in the embodiment.

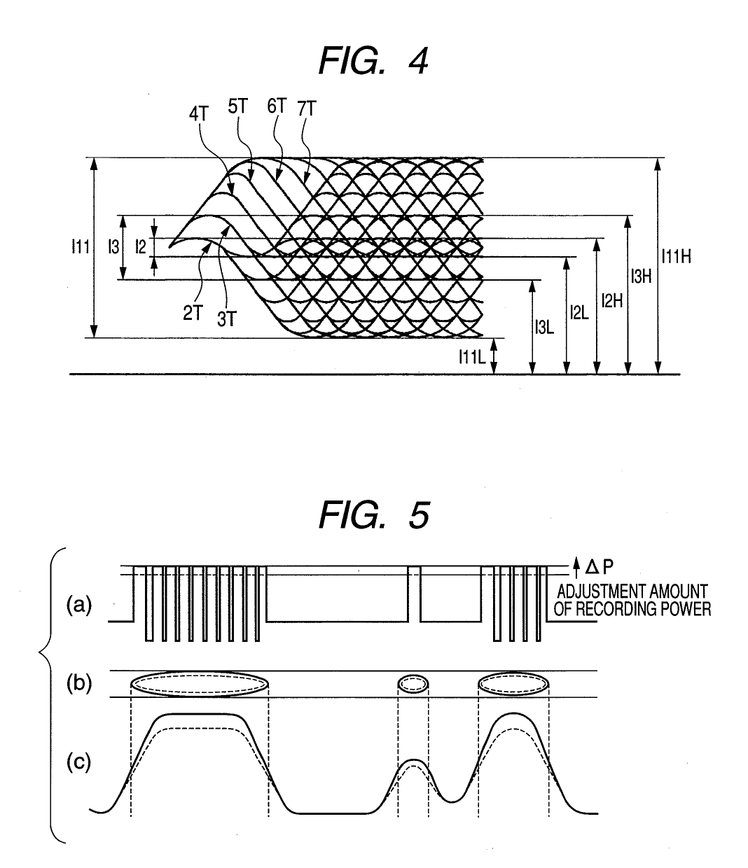

FIG. 4 is a diagram showing a method of calculation of asymmetry values for each code length. In the HD DVDs, user's data is recorded as the marks and spaces that have code lengths of 2T to 11T. FIG. 4 is a diagram in which readout signals of each code are displayed in a superposing manner.

In FIG. 4, I11H and I11L denote crest values of a mark and a space that have code lengths of 11T, I3H and I3L denote crest values of a mark and a space that have a code length of 3T, and I2H and I2L denote crest values of a mark and a space that have a code length of 2T. As shown in FIG. 3, the crest value of the mark or space having a shorter code length is smaller, and as the code length increases, the corresponding crest value increases. As shown in FIG. 4, when the code length is equal to or greater than 6T, the crest value does not change much.

When the notations shown in FIG. 4 are used, asymmetry values A_{2T} and A_{3T} of a space or a mark that have the code lengths of 2T and 3T are defined as the following equations.

A_{2T}=((I11H+I11L)/2−(I2H+I2L)/2)/(I11H−I11L) (Equation 2)

A_{3T}=((I11H+I11L)/2−(I3H+I3L)/2)/(I11−I11L) (Equation 3)

As a generalized expression, an asymmetry value A_{nT} of a mark or a space having the code length of nT can be calculated by using the following equation.

A_{nT}=((I11H+I11L)/2−(InH+InL)/2)/(I11H−I11L) (Equation 4)

As represented in the definition equations, the asymmetry value for the code length of nT is an index for indicating the degree of identity between a median value of the mark and the space for the maximum code length 11T and a median value of the mark and the space for the code length of nT. For a readout signal having an ideal waveform in which vertical symmetry is completely acquired, all the asymmetry values for each code length become zero.

In practical use, the asymmetry values do not become zero due to non-uniform characteristics of the optical disc or an optical disc apparatus that records/reproduces data on/from the optical disc or the like. Thus, in the embodiments of the invention, recording parameters such as a recording power level or a width of the recording pulse are controlled by using the asymmetry values (deviance amount from zero) for each code length which are calculated using Equations 2 to 4, and the asymmetry values for all the code lengths are processed to be close to zero.

In the first embodiment among these embodiments, only the recording power level is controlled such that an asymmetry value for a specific code length is close to zero, that is, within a predetermined range around zero.

Hereinafter, an asymmetry control method according to the first embodiment will be described.

FIG. 5 shows schematic diagrams of recording waveforms of different code lengths (FIG. 5(a)) the form of marks (FIG. 5(b)), and the waveform of the readout signals (FIG. 5(c)), when the recording power is changed by ΔP. Since the recording power is common to all code lengths, when the recording power changes, it is shown that all the crest values of readout signals having all the code lengths change, as an example. As the crest values change, the asymmetry values for each code length changes.

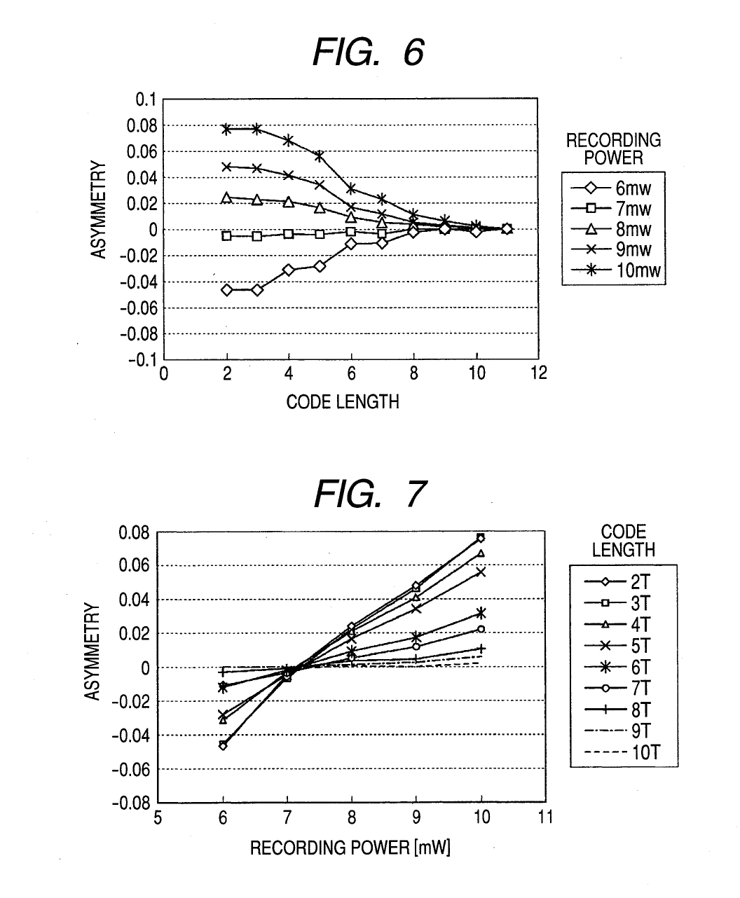

FIG. 6 is a graph showing a result of measured relationship between the recording power level and the asymmetry values for each code length, as an example. The horizontal axis of the graph denotes a code length, and the vertical axis of the graph denotes an asymmetry value. Each line corresponds to a specific recording power level. From this result of the measurement, it can be noticed that the asymmetry values change vertically together by changing the recording power level, although there are differences in sensitivity levels of the code lengths.

FIG. 7 shows a graph re-plotted as relationship between recording power levels and asymmetry values on the basis of the result of measurement shown in FIG. 6. In the graph, the horizontal axis represents the recording power levels and the vertical axis represents the asymmetry values, and each line corresponds to a specific code length. As shown in FIG. 7, there is a linear relationship between the recording power levels and the asymmetry values on the whole for each code length. It is known that there is a linear relationship between the recording power levels and the asymmetry values on the whole for any disc, although the absolute value of a slope of the linear characteristic (a sensitivity level of the asymmetry values for the recording power levels) or the absolute value of a recording power level at a point where the asymmetry value becomes zero is different due to characteristics of the optical disc or the like.

The asymmetry control method according to the first embodiment controls the recording power such that the asymmetry values for a specific code length become zero, in consideration with the linear relationship. Hereinafter, the asymmetry control method according to the first embodiment may be referred to as a specific code length OPC.

As the specific code length, any code length in the range of 2T to 11T may be used. However, when a code length, for which the sensitivity level of the linear characteristic is high, is used, the control process can be performed with high precision. In that sense, hereinafter, a case where 2T is selected as the specific code length will be described.

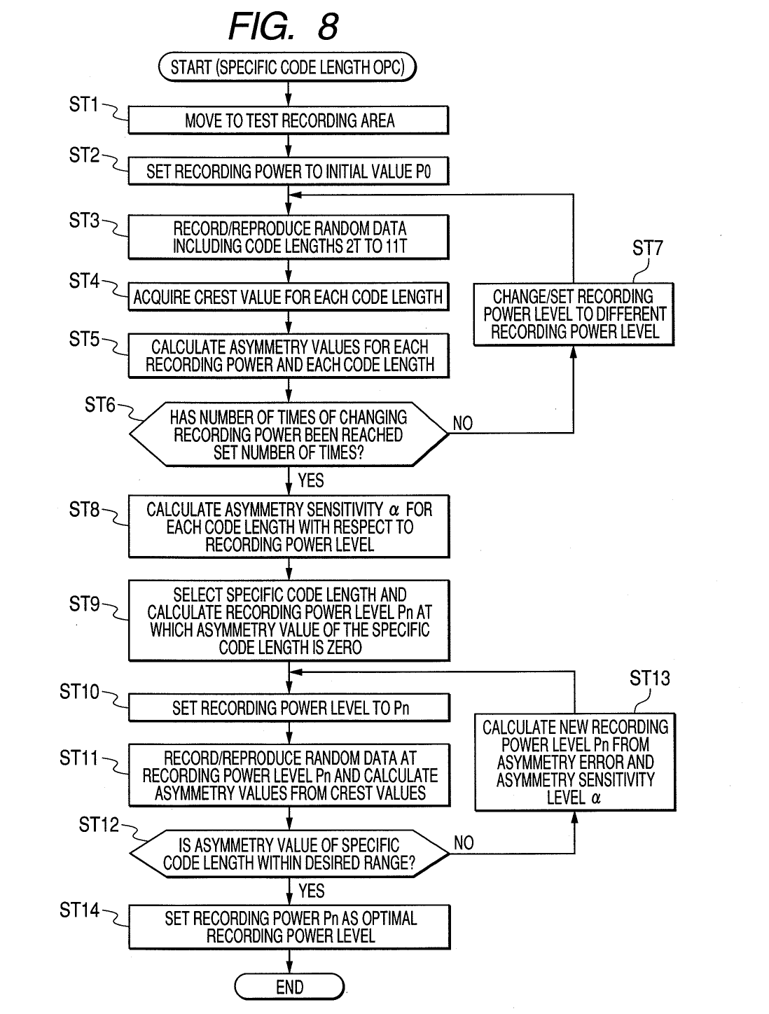

FIG. 8 is a flowchart showing a process of the asymmetry control method (specific code length OPC) according to the first embodiment, as an example.

At first, in step ST1, the optical pickup 3 is moved to a test recording area for the optical disc 100. In step ST2, a recording power level (initial value) P0 is set to the recording unit 6.

Thereafter, test data is recorded in the test recording area with the recording power level P0 being set and reproduces the recorded test data (step ST3). The test data, for example, is random data including data for all the code lengths (2T to 11T).

Next, an equalized readout signal (output data of the adaptive equalizer 67) is stored in an appropriate memory, and the crest values for each code length are acquired (step ST4). When the crest values are classified by the code lengths, a detected code length, which has been detected by using the decoding data output from the Viterbi decoding unit 80, may be used.

Next, the asymmetry values for each code length are calculated (step ST5). When 2T is selected as the specific code length, the asymmetry value A2T is calculated by using Equation 2. When a code length other than 2T is selected, the asymmetry value AnT is calculated by using Equation 4. The calculation of the asymmetry values is performed for each set recording power, and in the first loop, the initial value of the recording power is P0.

Next, in step ST6, the number of times of changes of the recording power is determined. In order to estimate a parameter for the linear characteristic between the recording power levels and the asymmetry values, at least two points of the recording power are used, and three or more points of the recording power may be used. Accordingly, the number of times of the changes of the recording power is set in advance, and it is determined whether the set number of times is reached in step ST6.

When the set number of times is not reached, the recording power is changed to a different recording power level in step ST7, and the process from step ST3 to step ST6 is repeated.

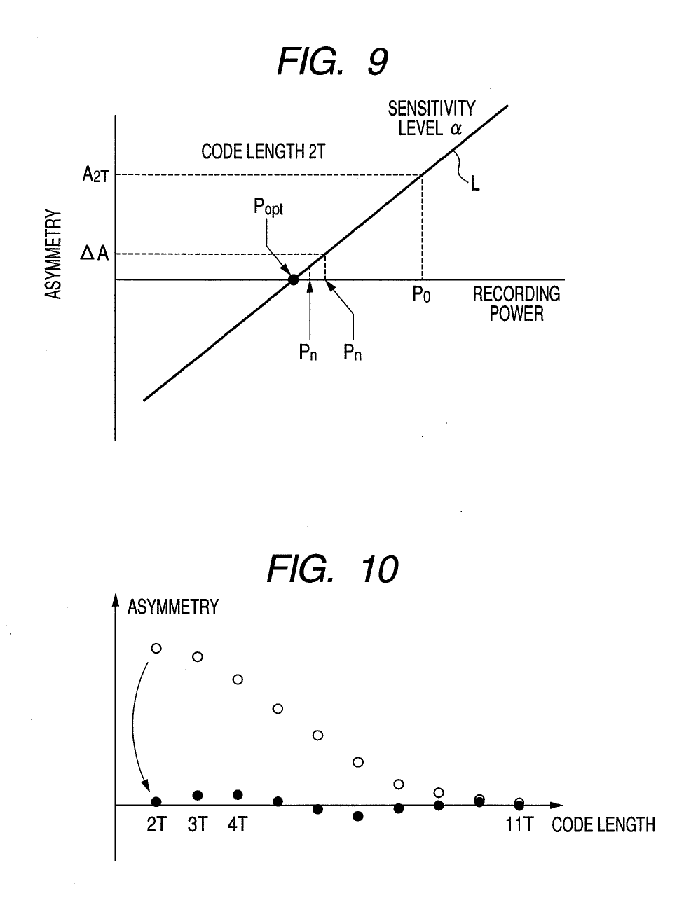

When the set number of times is reached, the process proceeds to step ST8. In step ST8, an approximate straight line L (see FIG. 9) is acquired on the basis of a plurality of set recording power levels and the asymmetry values (for example, the asymmetry values for the code length of 2T) calculated for each recording power level, and a sensitivity level a (the slope of the approximate straight line) for each recording power level is calculated on the basis of the acquired approximate straight line.

Next, a recoding power level Pn for which the asymmetry value for the specific code length (2T) approaches zero is calculated by using the following equation.

Pn=P0−(A_{2T,0}/α) (Equation 5)

For a code length nT other than 2T, the recording power level Pn is calculated by the following equation.

Pn=P0−(A_{nT,0/}α) (Equation 6)

Here, A_{2T, 0} or, A_{nT, 0} is the asymmetry value acquired for the code length 2T or nT when the recording power value is set to have an initial value P0.

Theoretically, the recording power that makes the asymmetry value zero can be calculated by performing the process once, but since there are various error factors in practical use, the asymmetry value does not always become zero by performing the process once. Accordingly, a process that puts the asymmetry value to be further within the predetermined range around zero is provided, and the process from step ST10 to step S12 corresponds to this process.

In step ST10, the calculated recording power Pn is set in the recording unit 6. Random data is recorded and reproduced while this status is maintained, thereby the asymmetry value is calculated from the crest values (step ST11). This process of step ST11 is substantially the same as the process of step ST3 to step ST5.

The asymmetry value acquired in this case is the asymmetry error ΔA shown in FIG. 9. In step ST12, it is determined whether the asymmetry error ΔA is within the predetermined range around zero.

When the asymmetry error is out of the predetermined range, a new recording power level Pn is calculated by using the following equation on the basis of the asymmetry error ΔA and the sensitivity level α previously acquired.

Pn←Pn−(ΔA/α) (Equation 7)

The new recording power level Pn calculated is set in the recording unit 6, and thereafter the process is repeated until the asymmetry error ΔA is within the predetermined range around zero.

When it is determined that the asymmetry error ΔA is within the predetermined range around zero, the recording power level Pn at the moment is set in the recording unit 6 as an optimal recording power level Popt.

Then, the process for the specific code length OPC is completed, and thereafter, a process for recoding ordinary user data is performed by using the optimal recording power level Popt.

FIG. 10 is a diagram showing a result of performing the specific code length OPC for the code length of 2T. In FIG. 10, white circles represent the asymmetry values for each code length before performance of the specific code length OPC, and black circles represent the asymmetry values for each code length after performance of the specific code length OPC. It is obvious that the asymmetry value for the code length of 2T after the performance of the specific code length OPC is in the vicinity of zero as a result of the process. In addition, asymmetry values for code lengths other than 2T are in the vicinity of zero on the whole.

The reason is, in FIG. 7, a recoding power level that makes the asymmetry value for the code length of 2T zero and recoding power levels that make the asymmetry values for code lengths other than 2T zero are in the same range (the range from 7 mW to 7.5 mW on the whole.

Hereinafter, an asymmetry control method according to a second embodiment is described. When the characteristic of an asymmetry value with respect to a code length shown in FIG. 6 is considered again, for example, the recording power level of 6 mW shows a descending characteristic of the asymmetry values, as the recording power level increases, the recording power level of 6 mW shows an approximately horizontal characteristic, and as the recording power level further increases, the recording power level of 6 mW shows an ascending characteristic. In other words, the slope of the characteristic of the asymmetry values with respect to the code lengths changes on the basis of the recording power level.

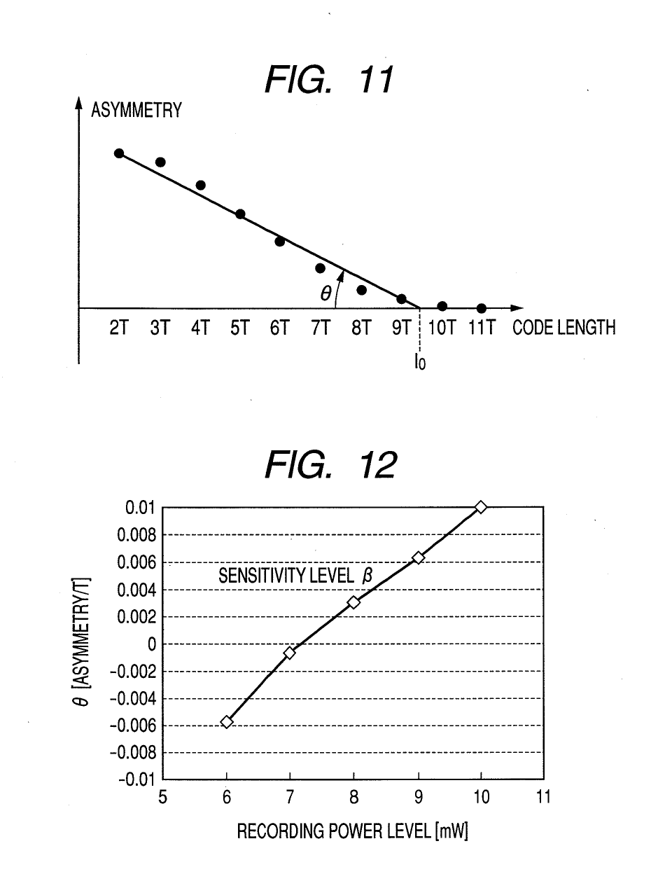

FIG. 11 is a diagram modeled as a straight line having an intersection I0 with the code length axis and a slope θ by extracting one characteristic of the asymmetric value with respect to the code length. In FIG. 11, it is implied that the asymmetry values for all the code lengths can be zero on the whole when the slope θ of the straight line becomes zero.

An asymmetry control method according to a second embodiment of the invention is a method in which the recording power level is controlled so as to make the slope θ of a characteristic line of the asymmetry values with respect to the code lengths zero and may be referred to as a linear approximation OPC in the following description.

In FIG. 12, a relationship between the recording power levels and the slopes θ that is experimentally acquired is shown. In the figure, it is shown that the slope θ changes along an approximate straight line with respect to the recording power. In other words, it is expected that there is a linear characteristic between the slope θ of the characteristic line of the asymmetry values with respect to the code lengths and the recording power levels. The asymmetry control method according to the second embodiment is a method in which the recording power levels are acquired such that the slope θ becomes zero by using the linear characteristic.

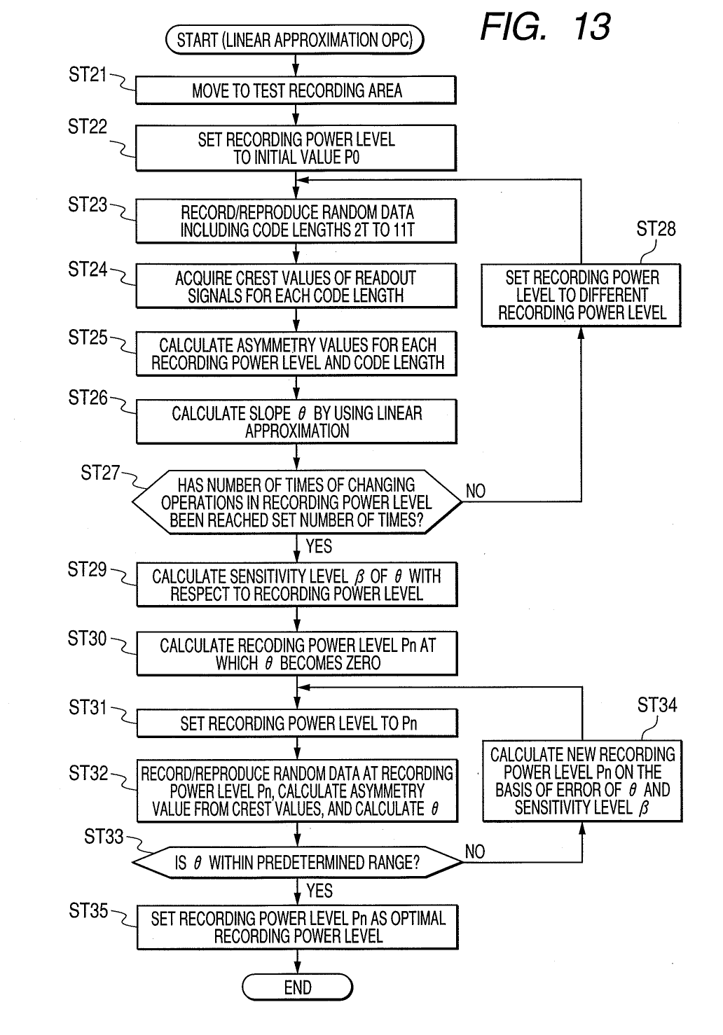

FIG. 13 is a flowchart showing a process of the asymmetry control method (linear approximation OPC) according to the second embodiment, as an example.

The process of step ST21 to step ST25 is the same as that in the first embodiment, and is a process in which asymmetry values at the recording power level (initial value) P0 for each code length are acquired.

In step ST26, the slope θ is acquired on the basis of an approximate straight line that is acquired by performing linear approximation for the acquired asymmetry values with respect to the code lengths. In the first loop, the slope θ for the recording power level (initial value) of P0 is acquired.

The same process is performed for a plurality of the recording power levels other than the recording power level of P0, whereby a plurality of slopes θ are acquired (step ST27 and step ST28).

Next, a sensitivity level β (see FIG. 12) of the slope θ with respect to the recording power level is calculated on the basis of the recording power levels corresponding to the acquired plurality of the slopes θ (step ST29).

Thereafter, the recording power Pn that makes the sensitivity level β zero is calculated by using the following equation (step ST30).

Pn=P0−(θ₀/β) (Equation 8)

Here, θ₀ is a slope θ that is acquired at the recording power level (initial value) of P0.

It cannot be determined that the slope θ becomes zero by performing the control process of the asymmetry control method according to the second embodiment once, and it may be assumed that an error Δθ remains. Accordingly, as in the first embodiment, a process for delicately controlling the recording power so as to make Δθ within the predetermined range around zero is performed. This process corresponds to a loop process from step ST31 to step ST34.

An equation for calculating a new recording power Pn is as follows.

Pn←Pn−(Δθ/β) (Equation 9)

When it is determined that the error Δθ is within the predetermined range around zero in step ST33, the recording power level Pn at that moment is set in the recording unit 6 as an optimal power level Popt.

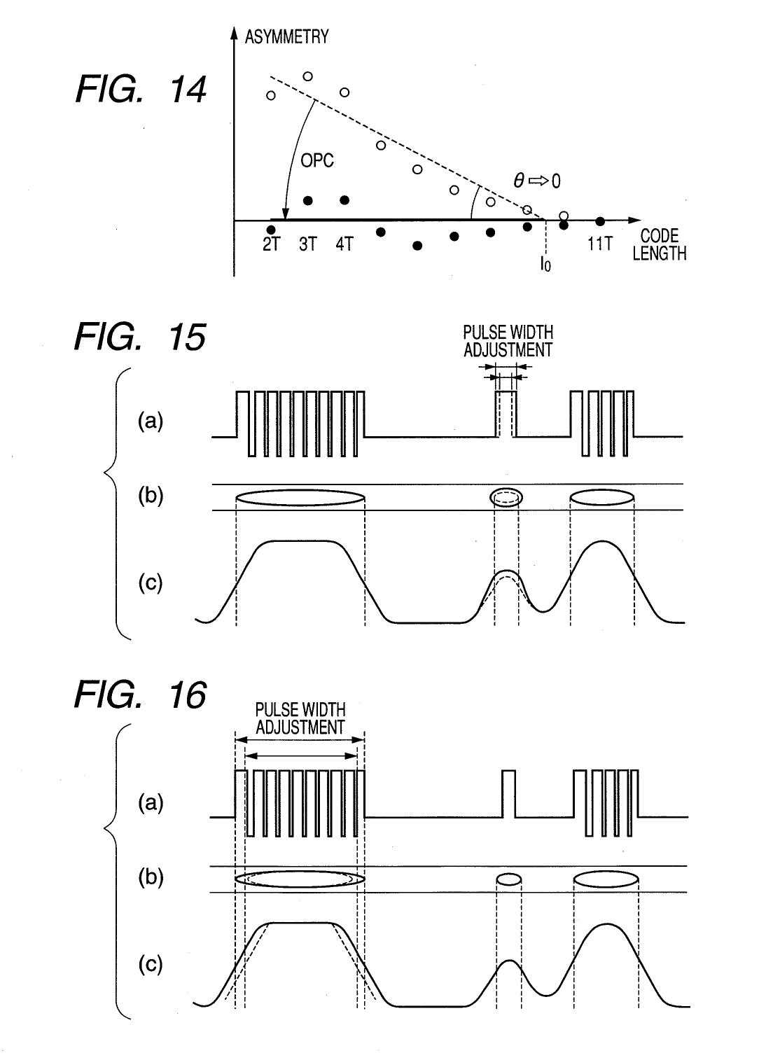

FIG. 14 is a diagram showing a result of performing the asymmetry control method (linear approximation OPC) according to the second embodiment, as an example. In FIG. 14, white circles represent the asymmetry values for each code length before performance of the linear approximation OPC, and black circles represent the asymmetry values for each code length after performance of the linear approximation OPC. It can be known that the asymmetry values for all the code lengths are close to zero on the whole.

The linear approximation OPC is a method in which the asymmetry values for all the code lengths are made to be close to zero on the average (not for a specific code length) by performing a linear approximation for the characteristic of the asymmetry value with respect to the code length. Accordingly, when the asymmetry values for all the code lengths are on the approximate straight line, the asymmetry values for all the code lengths can be approximately zero. To the contrary, when the asymmetry values for all the code lengths are dispersed away from the approximate straight line, an error in the asymmetry values remains.

Hereinafter, an asymmetry control method according to a third embodiment is described. Both the first embodiment (the specific code length OPC) and the second embodiment (the linear approximation OPC) are methods in which the asymmetry values are controlled to be close to zero by only controlling the recording power levels.

Accordingly, for example, in the first embodiment, when a recording power level that makes the asymmetry value for the code length of 2T zero and a recording power level that makes the asymmetry value for the code length other than 2T are quiet different from each other, there may be a case where it is difficult to make the asymmetry values for all the code lengths to be within the predetermined range around zero by only controlling the recording power level.

A third embodiment of the invention is a method that is effective in this case. The third embodiment is a control method in which a control process of the recording power level and a control process of pulse widths are combined.

FIG. 15 is a diagram for describing a process of controlling pulse widths. This process of controlling pulse widths can control the crest values of each code length, unlike the process of controlling recording power levels. For example, when a pulse width, which has a short code length, located in the center of FIG. 15(a) is shortened, an equivalent recording power decreases, whereby the crest value of the readout signal decreases as shown in FIG. 15(c). This means that crest values for each code length can be controlled by controlling the pulse widths for each code length, and as a result, the asymmetry values for each code length can be controlled.

While the asymmetry values for each code length can be controlled to be zero by performing the process of controlling pulse widths, there is a limitation that it is difficult to control the asymmetry values for a code length (for example, a code length equal to or greater than 6T) longer than a specific code length.

FIG. 16 is a schematic diagram for describing the reason. As shown in the left side of FIGS. 16(a), 16(b), 16(c), a center portion other than the both end portions of a waveform of a readout signal having a long code length is flat, and the crest values of the readout signal scarcely change although the pulse width is adjusted. This means that the asymmetry values do not change when the pulse width is adjusted for a long code length, whereby the asymmetry values cannot be controlled by adjusting the pulse width. From which length of the code length it is difficult to control the asymmetry values by performing the pulse width adjustment can be acquired on the analog of the waveform of the readout signal shown in FIG. 4. As shown in FIG. 4, while the crest values of readout signals having the code length of 2T to 5T increase slowly, the crest values of readout signals having the code length equal to or longer than 6T are approximately maintained at a constant value regardless of the length of the code lengths. This means that the asymmetry value control by performing the pulse width adjustment is not always effective for code lengths equal to or greater than 6T.

The asymmetry control method according to the third embodiment is capable of fixing the asymmetry values for all the code lengths including a code length equal to or greater than 6T around zero while complementing the above-described limitation of the pulse width adjustment.

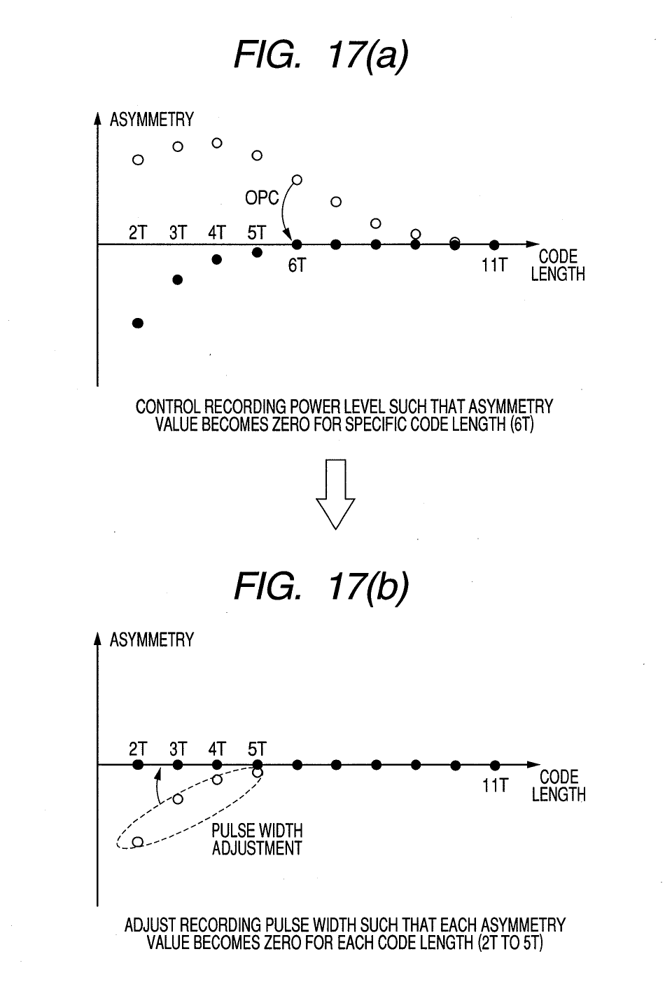

FIGS. 17(a), 17(b) are diagrams for describing a symmetry control method according to the third embodiment of the invention. In this control method, as shown in FIG. 17(a), a specific code length OPC (the asymmetry control method according to the first embodiment) is performed for a specific code length, for example, for a code length of 6T. As a result, the asymmetry values (white circles) before the asymmetry control are moved to positions of the asymmetry values (black circles) after the asymmetry control.

The asymmetry values can be fixed around zero by using the recording power control (the specific code length OPC) for a readout signal having a code length equal to or greater than 6T for which it is difficult to control the asymmetry values by the pulse width adjustment.

Next, as shown in FIG. 17(b), the pulse width adjustment is performed for short code lengths (in this example, the code length of 2T to 5T) for which the asymmetry control can be performed by the pulse width adjustment, thereby the asymmetry values are individually fixed around zero.

As described above, the asymmetry control method according to the third embodiment is a method combining the specific code length OPC and the asymmetry control method using pulse width adjustment. The code lengths selected for the specific code length OPC are code lengths for which all the asymmetry values cannot be controlled by using the pulse width control, for example, code lengths selected among code lengths of 6T or more, thereby the effectiveness of the asymmetry control method according to the third embodiment is improved.

When an asymmetry value for a specific code length is fixed around zero by the pulse width adjustment process for the code length, there are cases where symmetry values for other code lengths are affected. For example, when a pulse width for the code length of 3T is adjusted so as to make the asymmetry value for the code length of 3T zero, asymmetry values for code lengths other than the code length of 3T, for example, the asymmetry value for the code length of 2T or 4T is affected. In this case, the pulse widths for code lengths other than 3T are adjusted more or less together with the pulse width adjustment process for the code length of 3T.

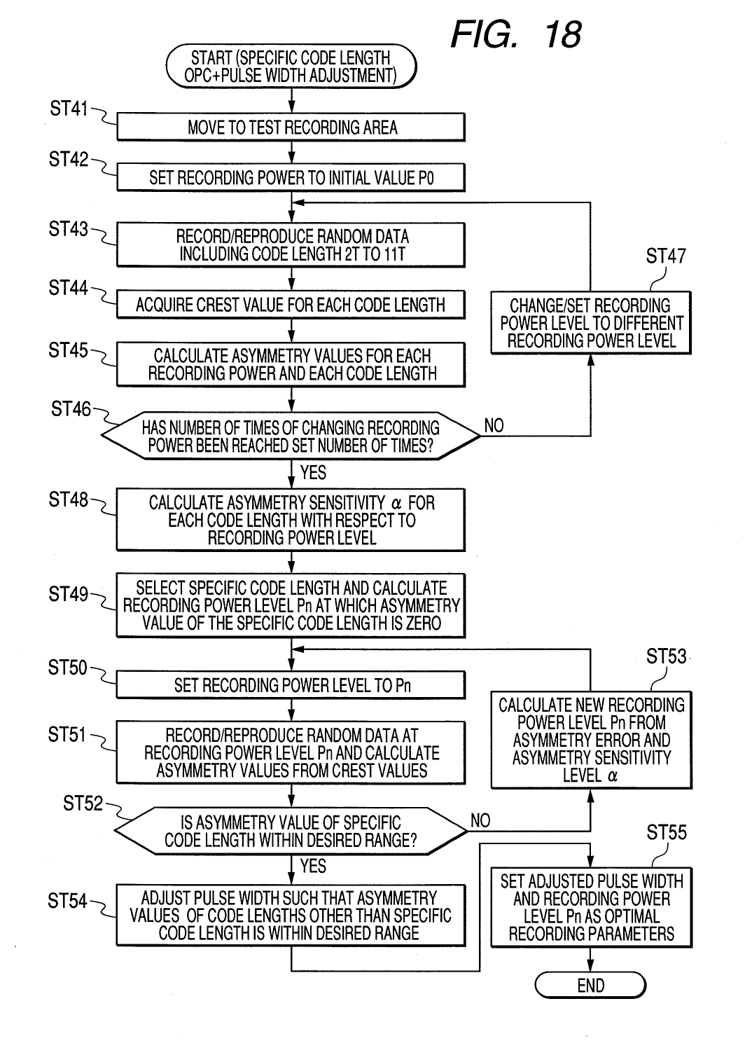

FIG. 18 is a flowchart showing a process of the asymmetry control method (the specific code length OPC+pulse width adjustment) according to the third embodiment, as an example.

The process of step ST41 to step ST52 are basically the same as the process of step ST1 to step ST12 in the first embodiment (the specific code length OPC: FIG. 8). However, the specific code length that is selected in step ST49 is, for example, selected among the code lengths equal to or greater than 6T, thereby the effectiveness of the third embodiment is improved.

In step ST52, when it is determined that an asymmetry value for a specific code length (for example, 6T) is in the predetermined range around zero, the process proceeds to step ST54. In step ST54, asymmetry values for each code length are controlled by the pulse with adjustment process. In this case, the code lengths for the asymmetry control process are code lengths other then the specific code length (for example, 6T), and more specifically, the code lengths (for example, 2T to 5T) shorter than the specific code length.

Hereinafter, an asymmetry control method according to a fourth embodiment is described. An asymmetry control method according to a fourth embodiment of the invention is a method combining the linear approximation OPC (the second embodiment) and the pulse width adjustment.

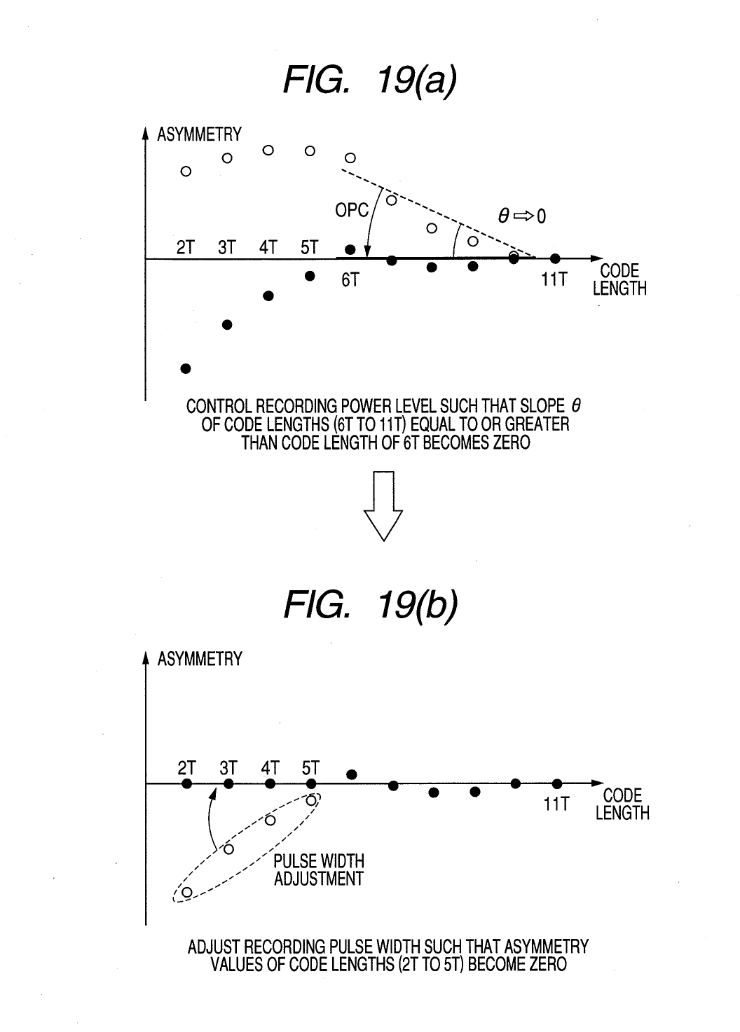

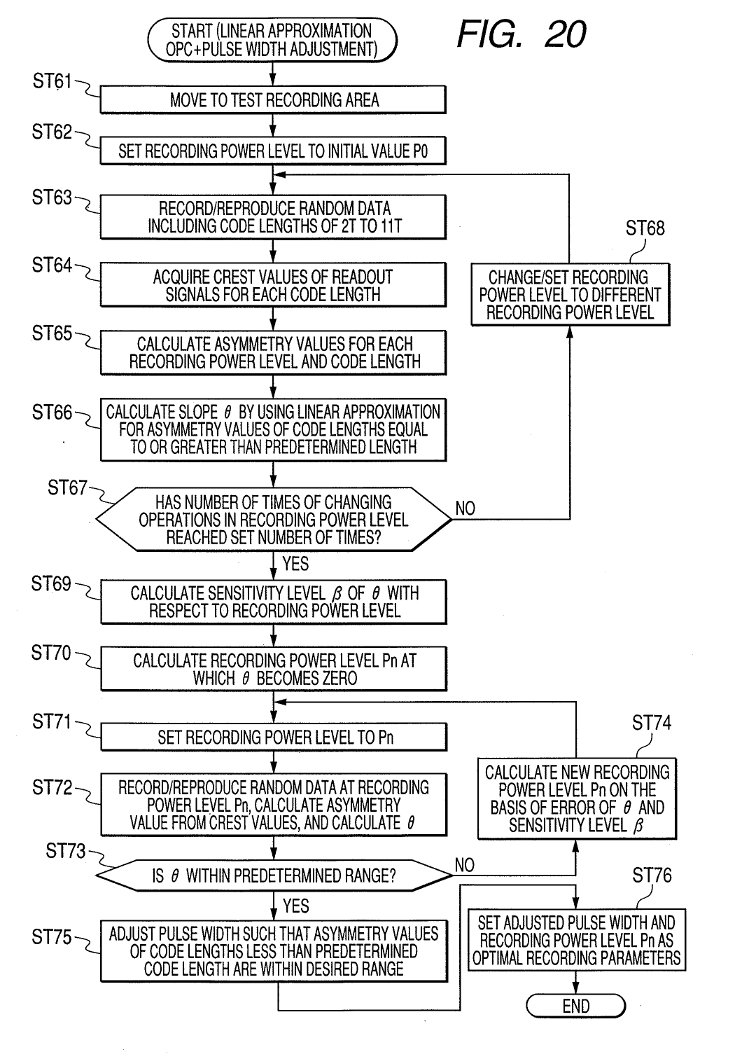

FIGS. 19(a), 19(b) are diagrams for describing the asymmetry control method according to the fourth embodiment.

At first, as shown in FIG. 19(a), a linear approximation OPC is performed. In this case, the target range for the linear approximation OPC includes long code lengths for which the asymmetry values cannot be sufficiently controlled by the pulse width adjustment. For example, code lengths equal to or greater than 6T are included in the target range for the linear approximation.

Even in a case where the asymmetry values for the whole code lengths have low linearity and the asymmetry values for all the code lengths cannot be sufficiently controlled by only the linear approximation OPC, when the target range for the linear approximation is limited to code lengths equal to or greater than 6T, linearity can be acquired, whereby the linear approximation OPC becomes more effective. In addition, when it is considered that the pulse width control is not effective for the asymmetry values for code lengths equal to or greater than 6T, there are double advantages by limiting the target range for the linear approximation.

On the other hand, for the asymmetry values (2T to 5T) for code lengths less than 6T, an individual asymmetry control process can be performed by the pulse width adjustment. By using this method, as shown in FIG. 19(b), even in a case where the asymmetry values have low linearity, it is possible to fix the asymmetry values in the vicinity of zero by performing the asymmetry control process for each code length.

FIG. 20 is a flowchart showing a process of the asymmetry control method according to the fourth embodiment, as an example.

The process of step ST61 to step ST74 is basically the same as the process of step ST21 to step ST34 in the second embodiment (the linear approximation OPC: FIG. 13). However, when the slope □ of the approximate line is to be calculated in step ST66, the target range for the calculation of the slope includes the asymmetry values for a predetermined code length or longer, for example, code lengths equal to or greater than 6T, the effectiveness of the fourth embodiment is improved.

When it is determined that the slope θ is in the predetermined range around zero in step ST73, the process proceeds to step ST75. In step ST75, a process of controlling asymmetry values for each code length by performing the pulse width adjustment is performed. In this case, the target code lengths for which the asymmetry values are controlled are code lengths, for example, 2T to 5T less than a predetermined code length (for example, 6T).

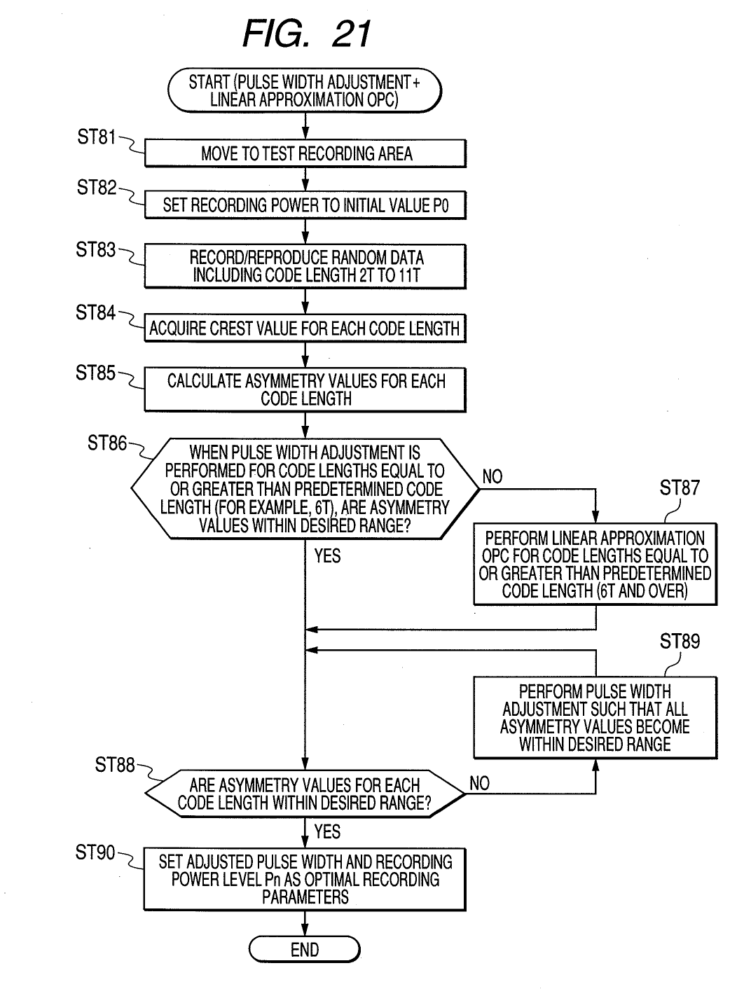

Hereinafter, asymmetry control method according to a fifth embodiment is described. FIG. 21 is a flowchart showing a process for an asymmetry control method according to the fifth embodiment.

The asymmetry control method according to the fifth embodiment is a method in which an asymmetry control process by using a pulse width adjustment process is primarily used and a recording power control process (in this case, the linear approximation OPC) is used only when the asymmetry values cannot be sufficiently controlled by the pulse width adjustment process.

In the process of step ST81 to ST85, the recording power level is set to an initial value P0 and the asymmetry values for each code length are calculated. This process is the same as that in other embodiments.

In step ST86, it is determined whether asymmetry values can be placed in the predetermined range around zero if a pulse width adjustment process is performed for the acquired asymmetry values for code lengths equal to or greater than a predetermined code length (for example, equal to or greater than 6T).

When it is determined that the asymmetry values cannot be placed in the predetermined range, the process proceeds to step ST87, and the linear approximation OPC is performed for asymmetry values for code lengths equal to or greater than a predetermined code length (for example, equal to or greater than 6T). After the linear approximation OPC is performed, the process proceeds to step ST88.

On the other hand, when it is determined that the asymmetry values even for code lengths equal to or greater than a predetermined code length (for example, equal to or greater than 6T) can be placed in the predetermined range by the pulse width adjustment process in step ST86, the process proceeds to step ST88.

In step ST88, it is determined whether all the asymmetry values for each code length are placed in the predetermined range around zero. If there is a code length for which the asymmetry value is not placed in the predetermined range, a pulse width control process is performed so as to place the asymmetry value for the code length in the predetermined range (step ST89). The above-described process is repeated until all the asymmetry values for all the code lengths are placed in the predetermined range.

When all the asymmetry values for all the code lengths are placed in the predetermined range, the adjusted pulse width and the recording power level are set in the recording unit 6 as the optimal pulse width and the optimal recording power, in step ST90 as a final step.

As described above, by using the optical disc 1 and optical disc recording and reproducing method that perform an asymmetry control method according to the above-described embodiments of the invention, asymmetry values for each code length can be appropriately controlled for code lengths in the broad range of a short code length to a long code length.

According to the above-described embodiments, by using an optical disc apparatus and an optical disc recording and reproducing method according to embodiments of the invention, it is possible to appropriately control asymmetries of code lengths in the broad range of a short code length to a long code length.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disc apparatus comprising:
a recording unit configured to record data on an optical disc using a laser beam by forming a mark and a space having a predetermined code length;
a crest value acquiring unit configured to acquire a crest value of the mark and the space for each of a plurality of code lengths from a readout signal of the optical disc;
an asymmetry calculation unit configured to calculate an asymmetry value for each of the plurality of code lengths based on the corresponding crest value; and
a recoding parameter determining unit configured to determine, based on a linear characteristic between the asymmetry value for each of the plurality of code lengths and a recording power level, a more optimal recording power level of the laser beam to set the asymmetry value for each code length within a predetermined range.

2. The optical disc apparatus of claim 1, wherein the recording parameter determining unit is configured to select an asymmetry value of a specific code length from the asymmetry values for each code length calculated by the asymmetry calculating unit, wherein the recording parameter determining unit is configured to determine a sensitivity level of the linear characteristic of the asymmetry value of the specific code length with respect to the recording power level, and wherein the recording parameter determining unit is configured to set, based on the determined sensitivity level, at least two or more recording power levels and to determine one of the recording power levels at which the asymmetry value of the specified code length comes within the predetermined range, as the more optimal recording power level.

3. The optical disc apparatus of claim 2, wherein, when a part of the asymmetry value for each code length is out of the predetermined range, the recording parameter determining unit is configured to adjust, by changing the pulse width, a recording pulse corresponding to the code length for which the part of the asymmetry value is out of the predetermined range so as to set the part of the asymmetry value of the code length within the predetermined range.

4. The optical disc apparatus of claim 1, wherein the recording parameter determining unit is configured to determine a slope of change of an asymmetry value with respect to a code length, based on the asymmetry value for each code length calculated by the asymmetry calculating unit, wherein the recording parameter determining unit determines a sensitivity level of the linear characteristic of the slope with respect to the recording power by setting at least two or more recording power levels in the recording unit, and wherein the recording parameter determining unit is configured to determine the recording power level at which the slope of change of the asymmetry value with respect to the code length approximately becomes zero as the more optimal power level based on the determined sensitivity level.

5. The optical disc apparatus of claim 4, wherein, when a part of the asymmetry value of the code length is out of the predetermined range, the recording parameter determining unit is configured to adjust, by changing the pulse width, a recording pulse corresponding to the part of the asymmetry value so as to set the part of the asymmetry value within the predetermined range.

6. The optical disc apparatus of claim 1, wherein the recording parameter determining unit is configured to set a predetermined recording power level and a pulse width of a recording pulse corresponding to each code length in the recording unit as an initial recording parameter, wherein the recording parameter determining unit is configured to determine, by changing the pulse width of the recording pulse, whether the asymmetry value for a code length equal to or greater than a specific code length calculated at a time when the initial recording parameter is set can be placed in the predetermined range, wherein, if it is determined that the asymmetry value is not placed in the predetermined range, the recording parameter determining unit is configured to determine a slope of change of the asymmetry value with respect to a code length equal to or greater than the specific code length and to determine, by setting at least two or more recording power levels in the recording unit, the sensitivity level of the linear characteristic of the slope of the change of the asymmetry value with respect to the recording power level, wherein the recording parameter determining unit is configured to determine, based on the determined sensitivity level, a recording power level at which the slope of change of the asymmetry value with respect to the code length approximately becomes zero as the more optimal power level, wherein, when the asymmetry value of a part of the code length is out of the predetermined range even though the more optimal recording power level is used, the recording parameter determining unit is configured to adjust, by changing the pulse width of the recording pulse corresponding to the part of the code length, the recording pulse so as to set the asymmetry value of the part of the code length within the predetermined range, and wherein, if it is determined, by changing the pulse width of the recording pulse, that the asymmetry value of the code length equal to or greater than the specific code length is placed in the predetermined range, the recording parameter determining unit is configured to determine whether the asymmetry value of all the code lengths is within the predetermined range, and wherein, when the asymmetry value of a part of all of the code lengths is not within the predetermined range, the recording parameter determining unit is configured to adjust, by changing the pulse width of the recording pulse corresponding to the part of all of the code lengths, the recording pulse so as to set the asymmetry value of the part of all of the code lengths within the predetermined range.

7. An optical disc recording and reproducing method comprising:
(a) recording data on an optical disc using a laser beam by forming a mark and a space having a predetermined code length;
(b) acquiring a crest value of the mark and the space for each of a plurality of code lengths from a readout signal of the optical disc;
(c) calculating an asymmetry value for each of the plurality of code lengths based on the corresponding crest value; and
(d) determining, based on a linear characteristic between the asymmetry value for each of the plurality of code lengths and a recording power level, a more optimal recording parameter so as to set the asymmetry value for each code length within a predetermined range.

8. The optical disc recording and reproducing method of claim 7, comprising:
selecting an asymmetry value of a specific code length from the asymmetry values for each code length calculated in the step (c);
determining, in step (d), a sensitivity level of the linear characteristic of the asymmetry value of the specific code length with respect to the recording power level by setting at least two or more recording power levels; and
determining, based on the determined sensitivity level, one of the recording power levels at which the asymmetry value of the specified code length comes within the predetermined range as the more optimal recording power level.

9. The optical disc recording and reproducing method of claim 8, comprising:
adjusting, in step (d), a pulse width of a recording pulse corresponding to a code length for which the part of the asymmetry value is out of the predetermined range, so as to set the part of the asymmetry value of the code length within the predetermined range if a part of the asymmetry value of the code length for each code length is out of the predetermined range,

10. The optical disc recording and reproducing method of claim 7, comprising:
determining a slope of change of an asymmetry value with respect to code length based on the asymmetry values for each code length calculated by the step (c);
determining a sensitivity level of the linear characteristic of the slope with respect to the recording power by setting at least two or more recording power levels in the recording unit; and
determining, based on the determined sensitivity level, the recording power level at which the slope of change of the asymmetry value with respect to the code length approximately becomes zero as the more optimal power level.

11. The optical disc recording and reproducing method of claim 10, comprising:
adjusting, by changing the pulse width, a recording pulse corresponding to the part of the asymmetry value so as to set the part of the asymmetry value within the predetermined range when a part of the asymmetry value of the code length is out of the predetermined range.

12. The optical disc recording and reproducing method of claim 7, comprising:
setting a predetermined recording power level and a pulse width of a recording pulse corresponding to each code length in the recording unit as an initial recording parameter;
determining, by changing the pulse width of the recording pulse, whether the asymmetry value for a code length equal to or greater than a specific code length among the asymmetry values calculated at a time when the initial recording parameter is set can be placed in the predetermined range;
determining a slope of change of the asymmetry value with respect to a code length equal to or greater than the specific code length if it is determined that the asymmetry value is not placed in the predetermined range;
determining, by setting at least two or more recording power levels in the recording unit, the sensitivity level of the linear characteristic of the slope of the change of the asymmetry value with respect to the recording power level;
determining, based on the determined sensitivity level, a recording power level at which the slope of change of the asymmetry value with respect to the code length approximately becomes zero as the more optimal power level;
adjusting, by changing the pulse width of the recoding pulse corresponding to the part of the code length, the recording pulse so as to set the asymmetry value of the part of the code length within the predetermined range when the asymmetry value of a part of the code length are out of the predetermined range even though the more optimal recording power level is used;
determining whether the asymmetry value of all the code lengths is within the predetermined range if it is determined, by changing the pulse width of the recording pulse, that the asymmetry value of the code length equal to or greater than the specific code length is placed in the predetermined range; and
adjusting, by changing the pulse width of the recording pulse corresponding to the part of all of the code lengths, the recording pulse so as to set the asymmetry value of the part of all of the code lengths within the predetermined range when the asymmetry value of a part of all of the code lengths is not within the predetermined range.
